(19) United States
(12) Patent Application Publication
(10) Pub. No.: US 2025/0330468 A1
(43) Pub. Date: Oct. 23, 2025

(54) SYSTEM AND METHOD FOR MANAGING USERS IN A NETWORK

(71) Applicant: JIO PLATFORMS LIMITED, Ahmedabad (IN)

(72) Inventors: Aditya GUPTA, Kamal (IN); Mukta SHETTY, Thane (IN); Apoorva KHAMESRA, Udaipur (IN); Milankumar KALAVADIYA, Jamnagar (IN)

(73) Assignee: JIO PLATFORMS LIMITED, Ahmedabad (IN)

(21) Appl. No.: 18/873,389

(22) PCT Filed: Jun. 29, 2023
(86) PCT No.: PCT/IB2023/056780

§ 371 Date: Dec. 10, 2024

(30) Foreign Application Priority Data
Jun. 29, 2022 (IN) 202221037375

(51) Int. Cl. H04L 9/40; H04L 67/141; H04L 69/40

(52) U.S. Cl. CPC H04L 63/0892; H04L 67/141; H04L 69/40

(57) ABSTRACT

The present disclosure provides a system for managing users in a network. The system includes a processor configured to receive a request via one or more computing devices; establish a binding session with a primary control plane function based on the user session; receive an authentication authorization request (AAR) from an application function based on a session data corruption associated with the user session; transmit the AAR to the control plane function to determine a particular control plane function associated with the primary control plane function processing the user session based on the binding session; and transmit the AAR to a network function to process the user session via an secondary control plane function based on receiving an error message from the particular control plane function.

### FIELD OF INVENTION

The embodiments of the present disclosure generally relate to wireless communication systems. More particularly, the present disclosure relates to systems and methods for managing users in a network.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Generally, in telecommunications networks, a service endpoint may be an address on a network node that uniquely identifies an entity that provides service to service consumers. The service endpoint can include an Internet Protocol (IP) address or a combination of IP address and transport-layer port number, which may also be referred to as an IP endpoint. Similarly, in 5G telecommunications networks, the network node that provides service may be referred to as a producer Network Function (NF). A network node that consumes services may be referred to as a consumer NF. The NF can be both a producer NF and a consumer NF depending on whether it is consuming or providing service. A given producer NF may have many service endpoints. The producer NFs may register with a Network function Repository Function (NRF). The NRF maintains an NF profile of available NF instances and their supported services. Further, the consumer NFs can subscribe to receive information about producer NF instances that have registered with the NRF.

In addition to consumer NFs, another type of network node that can subscribe to receive information about NF service instances is a Service Communications Proxy (SCP). The SCP subscribes with the NRF and obtains reachability and service profile information regarding producer NF service instances. The consumer NFs connect to the service communications proxy, and the service communications proxy load balances traffic among the producer NF service instances, that provide the required service or directly routes the traffic to the destined producer NF.

Further, the process of creating a Packet Data Unit (PDU) session includes a process of selecting a Session Management Function (SMF) by an Access and Mobility management Function (AMF), and a process of selecting a User Plane Function (UPF) by the SMF. When selecting the SMF, the AMF may select the SMF meeting a certain parameter requirement. For example, the AMF may send a certain parameter requirement to the NRF, and the NRF selects the SMF meeting the parameter requirement and sends the selection result to the AMF. Further, a Binding Support Function (BSF) may enable other Network Functions (NFs), for example, an Internet protocol Multimedia Subsystem (IMS) Call Session Control Function (CSCF) or a Network Exposure Functions (NEF), to determine which a Policy Control Function (PCF) is holding needed policy and accounting information for each active User Equipment (UE) data session. Further, the BSF may provide a support management service operations including register, de-register, and discovery operations. In addition, the BSF also provides proxy support for a Reception (Rx) Interface. As part of proxy support for the Rx interface, the BSF may look up binding data stored during register operation to find the PCF currently serving the session and forward an Authorization Authentication Request (AAR) message to the destination PCF.

Conventionally, there may be scenarios where either the PCF returns an error code such as 5065 (indicating that an Internet Protocol Connectivity Access Network (IP-CAN) session is not available), or the PCF itself is not reachable, or the BSF is not able to find the binding data locally. In all these cases, the BSF returns an error to the Call Session Control Function (CSCF)/Application Function (AF) (CSCF/AF). In these cases, the subscriber session may not be released/re-established, and chances are that subscriber may retry the call, which may have the same result eventually causing restricted services for the subscriber till the subscriber manually restarts the respective UE. In case the PCF returns 5065 (or any other error code or is unreachable), the BSF transparently passes the error to the AF/CSCF (via Diameter Routing Agent (DRA)). In addition, a Fourth Generation (4G) equivalent behaviour, where the DRA may be releasing a Gx session may not be currently implemented.

However, as the BSF is not aware of the SMF (or PDU Session ID), the BSF may not connect with the SMF for releasing a session. Further, the BSF may store the binding data in a Supplementary Downlink (SDL). Hence, in case the SDL is unreachable (Partial or Full) from the BSF session management, there may be scenarios where the BSF may not be able to find the binding data. In these cases, the BSF returns a 5065 error code to the AF/CSCF via the DRA. Further, as the BSF may not be aware of the SMF (or PDU Session ID), the BSF may not connect with the SMF for releasing of a session. In a scenario, when the BSF is not able to find the binding data (please note that for unique Subscription Permanent Identifier (SUPI)+Data Network Name (DNN)+slice, the BSF only stores single binding), the BSF may return 5065 error and results in that the BSF may not connect with the SMF for releasing of a session. Further, conventional systems using a Unified Data Manager function (UDM) functionality, where an external trigger (called via Application Programming Interfaces (APIs)) may result in the UDM/a Home Subscriber Server (HSS) initiating communication with AMF/mobility management entity (MME) to deregister and reregister the subscriber. The BSF may be responsible for finding the cases based on responses received from the PCF or local. The UDM and AMF/(HSS and MME) may need to interact as per standard to ensure that the subscriber may be deregistered first and then again registered to the network. In case of the 4G network, as Gx and Rx binding data was present with the DRA, all such decisions including session release of Gx may be taken by the DRA. In case of 5G, the BSF does not have Gx/N7 information to De-Register/Re-Register subscribers.

There is therefore a need in the art to provide systems and methods for managing users in a network, that can overcome the shortcomings of the existing prior art.

### OBJECTS OF THE PRESENT DISCLOSURE

Some of the objects of the present disclosure, which at least one embodiment herein satisfy are as listed herein below.

An object of the present disclosure is to provide systems and methods for managing users in a network.

Another object of the present disclosure is to provide systems and methods for De-Registering/Re-Registering a subscriber by triggering the appropriate Application Programming Interface (API) to a Unified Data Manager function (UDM).

Another object of the present disclosure is to overcome the overloading of the Unified Data Manager function (UDM) by the Binding Support Function (BSF), in case of bulk session failure from the Policy Control Function (PCF) or at the BSF.

Another object of the present disclosure is to provide systems and methods for removing binding data (and/or diameter data), if applicable for Subscription Permanent Identifier (SUPI) for which UDM API has been triggered.

Yet another object of the present disclosure is to resolve the issue of restarting User Equipment (UE) for network faults or Rx Session establishment with error, based on providing network-initiated action based on rare occurrences for such cases by initiating communication to the UDM and sending “ReRegister” service operation to UDM.

### SUMMARY

This section is provided to introduce certain objects and aspects of the present disclosure in a simplified form that are further described below in the detailed description. This summary is not intended to identify the key features or the scope of the claimed subject matter.

In a first aspect, the present disclosure provides system for managing users in a network. The system includes a processor and a memory operatively coupled with the processor. The memory stores instructions executable by the processor. The processor is configured to receive a request via one or more computing devices. The computing devices are associated with one or more users. The request is based on a user session requested by the one or more users. The processor is further configured to establish a binding session with a primary control plane function based on the user session. The processor is further configured to receive an authentication authorization request (AAR) from an application function based on a session data corruption associated with the user session. The processor is further configured to transmit the AAR to the control plane function to determine a particular control plane function associated with the primary control plane function processing the user session based on the binding session. The processor is further configured to transmit the AAR to a network function to process the user session via an secondary control plane function based on receiving an error message from the particular control plane function.

In an embodiment, the processor is further configured to re-establish the user session by receiving a protocol data unit (PDU) session from the secondary control plane function.

In an embodiment, the processor is further configured to terminate the user session by receiving the PDU session from the secondary control plane function.

In an embodiment, the secondary plane function is configured to process the user session via an access and mobility management function (AMF).

In an embodiment, the processor is further configured to terminate the binding session upon the re-establishment of the user session and transmit the error message to the application function.

In an embodiment, the processor is further configured to activate the secondary control plane function automatically prior to transmitting the error message to the application function.

In an embodiment, the binding session includes any one or a combination of a subscription permanent identifier (SUPI), a data network name (DNN), and a network slice associated with the user session.

In an embodiment, the primary control plane function is a policy control function (PCF). The secondary control plane function is a unified data manager function (UDM).

In a second aspect, the present disclosure provides a method for managing users in a network. The method includes receiving, by a processor associated with a system, a request via one or more computing devices. The request is based on a user session requested by the one or more users. The method further includes establishing, by the processor, a binding session with a primary control plane function based on the user session. The method further includes receiving, by the processor, an authentication authorization request (AAR) from an application function based on a session data corruption associated with the user session. The method further includes transmitting, by the processor, the AAR to the control plane function to determine a particular control plane function associated with the primary control plane function processing the user session based on the binding session. The method further includes transmitting, by the processor, the AAR to a network function to process the user session via an secondary control plane function based on receiving an error message from the particular control plane function.

In an embodiment, the method further includes re-establishing, by the processor, the user session by receiving a protocol data unit (PDU) session from the secondary control plane function.

In an embodiment, the method further includes terminating, by the processor, the user session by receiving the PDU session from the secondary control plane function.

In an embodiment, the method further includes terminating, by the processor, the binding session upon the re-establishment of the user session and transmitting the error message to the application function.

In an embodiment, the method further includes activating, by the processor, the secondary control plane function automatically prior to transmitting the error message to the application function.

In an embodiment, the binding session includes any one or a combination of a subscription permanent identifier (SUPI), a data network name (DNN), and a network slice associated with the user session.

In an embodiment, the primary control plane function is a policy control function (PCF). The secondary control plane function is a unified data manager function (UDM).

In a third aspect, the present disclosure provides a non-transitory computer readable medium including a processor with executable instructions. The processor is configured to receive a request via one or more computing devices. The computing devices are associated with the one or more users. The request is based on a user session requested by the one or more users. The processor is further configured to establish a binding session with a primary control plane function based on the user session. The processor is further configured to receive an authentication authorization request (AAR) from an application function based on a session data corruption associated with the user session. The processor is further configured to transmit the AAR to the control plane function to determine a particular control plane function associated with the primary control plane function processing the user session based on the binding session. The processor is further configured to transmit the AAR to a network function to process the user session via an secondary control plane function based on receiving an error message from the particular control plane function.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components, or circuitry commonly used to implement such components.

FIG. 1 illustrates an exemplary network architecture in which or with which the proposed system of the present disclosure can be implemented, in accordance with an embodiment of the present disclosure;

FIG. 2 illustrates an exemplary block diagram representation of the proposed system for managing users in a network, in accordance with an embodiment of the present disclosure;

FIG. 3A illustrates an exemplary block diagram representation of system architecture for managing users in a network, in accordance with an embodiment of the present disclosure;

FIG. 3B illustrates an exemplary sequence diagram representation for managing users in a network, in accordance with an embodiment of the present disclosure;

FIG. 4 illustrates an exemplary flow diagram for a method for managing users in a network, in accordance with an embodiment of the present disclosure; and

FIG. 5 illustrates an exemplary computer system in which or with which embodiments of the present invention can be utilized, in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Various embodiments of the present disclosure provide systems and methods for managing users in a network. The present disclosure provides systems and methods for De-Registering/Re-Registering of a subscriber by triggering the appropriate Application Programming Interface (API) to a Unified Data Manager function (UDM). The present disclosure overcomes overloading of the Unified Data Manager function (UDM) by the Binding Support Function (BSF), in case of bulk session failure from the Policy Control Function (PCF) or at the BSF. The present disclosure provides systems and methods for removing binding data (and/or diameter data), if applicable for Subscription Permanent Identifier (SUPI) for which UDM API has been triggered. The present disclosure resolves the issue of restarting User Equipment (UE) for network faults or Rx Session establishment with error, based on providing network-initiated action based on rare occurrences for such cases by initiating communication to the UDM and sending “ReRegister” service operation to UDM.

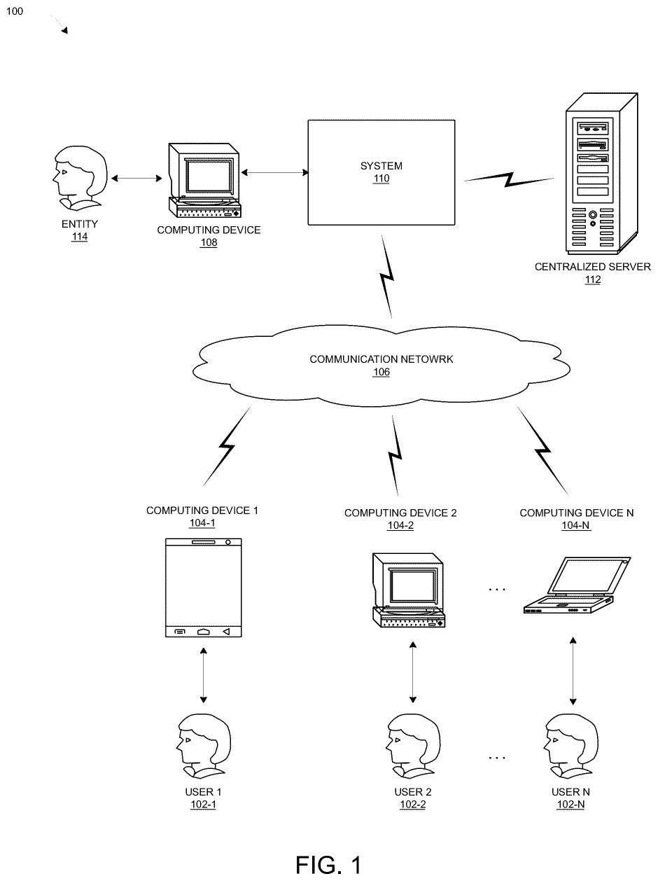

Referring to FIG. 1 that illustrates an exemplary network architecture for subscriber session releasing system (100) (also referred to as network architecture (100)) in which or with which a system (110) or simply referred to as the system (110) of the present disclosure can be implemented, in accordance with an embodiment of the present disclosure. As illustrated, the exemplary architecture (100) may be equipped with the system (110) for managing users in a network for one or more subscribers such as one or more users (102-1, 102-2, 102-3, . . . , 102-N) (individually referred to as the user (102) and collectively referred to as the users (102)) associated with one or more first computing devices (104-1, 104-2 . . . 104-N) (individually referred to as the first computing device (104) and collectively referred to as the first computing devices (104)).

The network may include, but is not limited to, a Third Generation (3G), a Fourth Generation (4G), a Fifth Generation (5G), a Sixth Generation (6G), a New Radio (NR), a Narrow Band Internet of Things (NB-IoT), an Open Radio Access Network (O-RAN), and the like. The system (110) may be further operatively coupled to a second computing device (108) associated with an entity (114). The entity (114) may include a company, an organization, a university, a lab facility, a company, a network operator, a vendor, a manufacturing unit, a network operator, a business enterprise, a defence facility, or any other secured facility. In some implementations, the system (110) may also be associated with the second computing device (108). Further, the system (110) may also be communicatively coupled to the one or more first computing devices (104) via a communication network (106).

The system (110) may be coupled to a centralized server (112). The centralized server (112) may also be operatively coupled to the one or more first computing devices (104) and the second computing device (108) through the communication network (106). In some implementations, the system (110) may also be associated with the centralized server (112).

In an embodiment, the system (110) may be communicatively connected to a core network (not shown in FIG. 1) such as the 3G, 4G, 5G, 6G, NR, NB-IoT, O-RAN, and the like, for managing users in a network.

In an embodiment, the system (110) may identify through a Binding Support Function (BSF) (not shown in FIG. 1) various cases, where subscriber needs to be deregistered and reregistered in a network by triggering the appropriate Application Programming Interface (API) to a Unified Data Manager function (UDM). In addition, the BSF may not overload UDM in case of a bulk session failure from a Policy Control Function (PCF) or at the BSF. Further, behaviour may be user-configurable error codes/timeout/Connection status, and the like, at the BSF.

In an embodiment, the BSF may include a run-time configuration to support multiple Internet Protocols (IPs) (2 Local IPs and 2 GR IPs) as destinations for the UDM. The BSF may also support retry for failed/timeout transactions where the error code may be user-configurable. Further, a local IP/Port (BSF Side) which may be used for communication with the UDM may be runtime configurable. Further, a maximum Transaction Per Second (TPS) rate at which API calls to the UDM may be runtime configurable. Further, the API to be used to UDM may be user-configurable. This may include, but is not limited to, a Token, JSON body (with only Subscription Permanent Identifier (SUPI) as a variable in JSON/header), flags, path, and the like. In an embodiment, the BSF may include a run-time flag to enable/disable the API to be used to the UDM.

In an embodiment, the BSF may support a manual command line for triggering the API for specific SUPI. Further, the BSF may be able to remove the binding data (and/or diameter Data), if applicable for SUPI for which the UDM API has been triggered. In addition, the BSF may provide appropriate logs, alarms, and counters to remove the binding data. Further, the UDM may provide the API guide for implementation at the BSF. Also, communication between the UDM and an Access and Mobility management Function (AMF)/Home Subscriber Server (HSS) and the MME may be finalized based on the API.

In an embodiment, the system (110) may create a binding session via the PCF in the BSF upon reception of a “Npcf_SMPolicyControl_Create/Update” message, by transmitting a “Nbsf_Management_Register” message to the BSF. Due to database fault or network fault, the session for the SUPI in question may be deleted from the PCF, but not from the BSF or a Session Management Function (SMF).

In an embodiment, the system (110) may transmit, in case of call initiation, an Authorization Authentication Request (AAR) message, from a Call Session Control Function (CSCF)/Application Function (AF) (CSCF/AF) to the BSF.

In an embodiment, the system (110) may trigger the BSF to check local DB for binding data for SUPI in question and find an entry for the binding data. Based on the entry, the BSF forwards the AAR to an appropriate PCF. As the PCF may not include session data for the SUPI, the PCF may respond with a 5065 result code to the BSF.

In an embodiment, the system (110) may initiate, upon receiving the error code by the BSF, via the BSF, communication to the UDM and transmit a “ReRegister” service operation to the UDM.

In an embodiment, the system (110) may internally interact, upon receiving the “ReRegister” service operation by the UDM, via the UDM, with the AMF/SMF to decide to send a notification to the SMF to either delete/re-establish the PDU Session or may also decide to deregister and register the subscriber via the AMF.

In an embodiment, the system (110) may trigger the BSF to remove the binding data from self and forwards a 5065 error code to the AF/CSCF.

In an embodiment, the system (110) may be a System on Chip (SoC) system but not limited to the like. In another embodiment, an onsite data capture, storage, matching, processing, decision-making, and actuation logic may be coded using Micro-Services Architecture (MSA) but not limited to it. A plurality of microservices may be containerized and may be event-based to support portability.

In an embodiment, the network architecture (100) may be modular and flexible to accommodate any kind of changes in the system (110) as proximate processing may be acquired towards managing users in a network. The system (110) configuration details can be modified on the fly.

In an embodiment, the system (110) may be remotely monitored and the data, application, and physical security of the system (110) may be fully ensured. In an embodiment, the data may get collected meticulously and deposited in a cloud-based data lake to be processed to extract actionable insights. Therefore, the aspect of predictive maintenance can be accomplished.

In an exemplary embodiment, the communication network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of: a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber-optic network, some combination thereof.

In another exemplary embodiment, the centralized server (112) may include or comprise, by way of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof.

In an embodiment, the one or more first computing devices (104), and the one or more second computing devices (108) may communicate with the system (110) via a set of executable instructions residing on any operating system, including but not limited to, Android™, iOS™, Kai OS™, and the like. In an embodiment, one or more first computing devices (104), and the one or more second computing devices (108) may include, but are not limited to, any electrical, electronic, electro-mechanical or an equipment or a combination of one or more of the above devices such as mobile phone, smartphone, Virtual Reality (VR) devices, Augmented Reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as a touchpad, touch-enabled screen, electronic pen, receiving devices for receiving any audio or visual signal in any range of frequencies and transmitting devices that can transmit any audio or visual signal in any range of frequencies. It may be appreciated that the one or more first computing devices (104), and the one or more second computing devices (108) may not be restricted to the mentioned devices and various other devices may be used. A smart computing device may be one of the appropriate systems for storing data and other private/sensitive information.

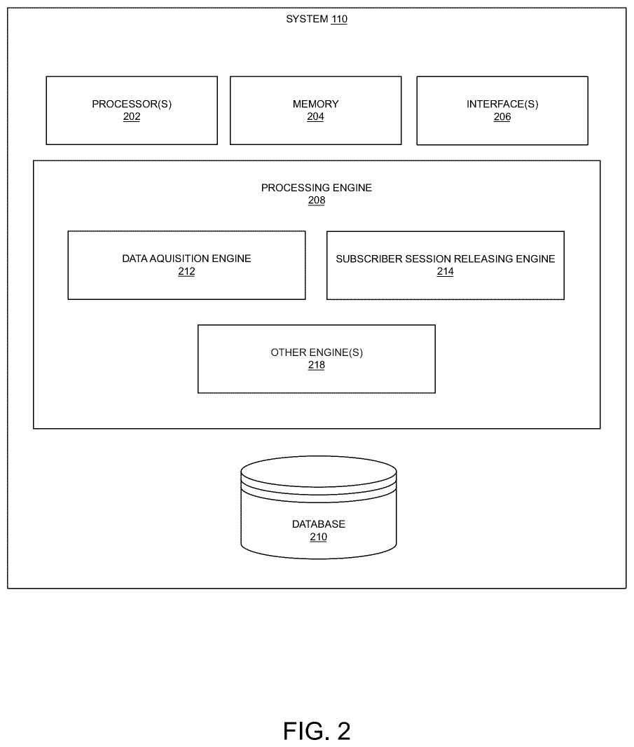

FIG. 2 illustrates an exemplary block diagram representation of the proposed system (110) for managing users in a network, in accordance with an embodiment of the present disclosure. In an aspect, the system (110) may include one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, one or more processor(s) (202) may be configured to fetch and execute computer-readable instructions stored in a memory (204) of the system (110). The memory (204) may be configured to store one or more computer- readable instructions or routines in a non-transitory computer-readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (110) may include an interface(s) 206. The interface(s) (206) may comprise a variety of interfaces, for example, interfaces for data input and output devices, referred to as Input/Output (I/O) devices, storage devices, and the like. The interface(s) (206) may facilitate communication of the system (110). The interface(s) (206) may also provide a communication pathway for one or more components of the system (110). Examples of such components include, but are not limited to, processing unit/engine(s) (208) and a database (210).

The processing unit/engine(s) (208) may be implemented as a combination of hardware and programming (for example, programmable instructions) to implement one or more functionalities of the processing engine(s) (208). In the examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

The processing engine (208) may include one or more engines selected from any of a data acquisition engine (212), a subscriber session releasing engine (214), and other engines/units (216). The processing engine (208) may further edge-based micro service event processing but is not limited to the like.

In an embodiment, the data acquisition engine (212) may identify through a Binding Support Function (BSF) (not shown in FIG. 1) various cases, where subscriber needs to be deregistered and reregistered in a network by triggering the appropriate Application Programming Interface (API) to a Unified Data Manager function (UDM). In an embodiment, the subscriber session releasing engine (214) may create a binding session via the PCF in the BSF upon reception of a “Npcf_SMPolicyControl_Create/Update” message, by transmitting a “Nbsf_Management_Register” message to the BSF. Due to database fault or network fault, the session for the SUPI in question may be deleted from the PCF, but not from the BSF or a Session Management Function (SMF). In an embodiment, the subscriber session releasing engine (214) may trigger the BSF to remove the binding data from self and forwards a 5065 error code to the AF/CSCF.

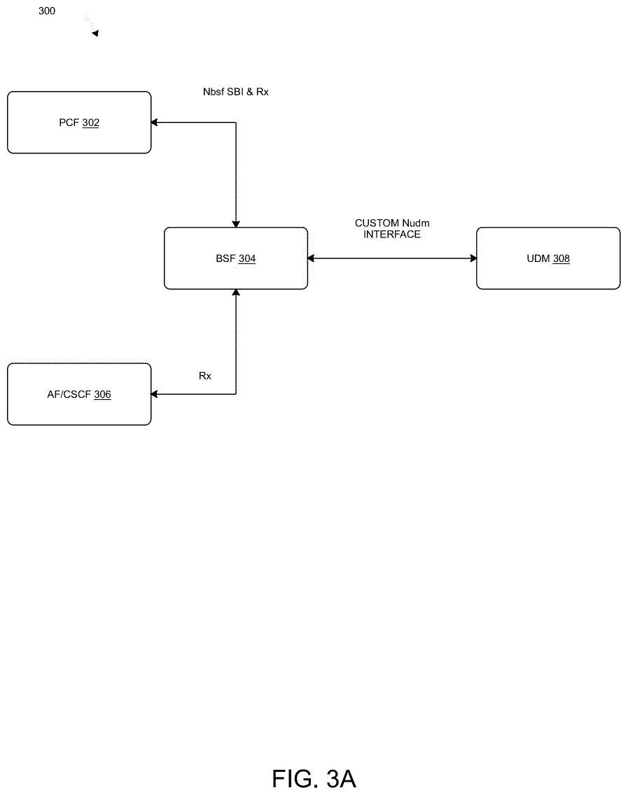

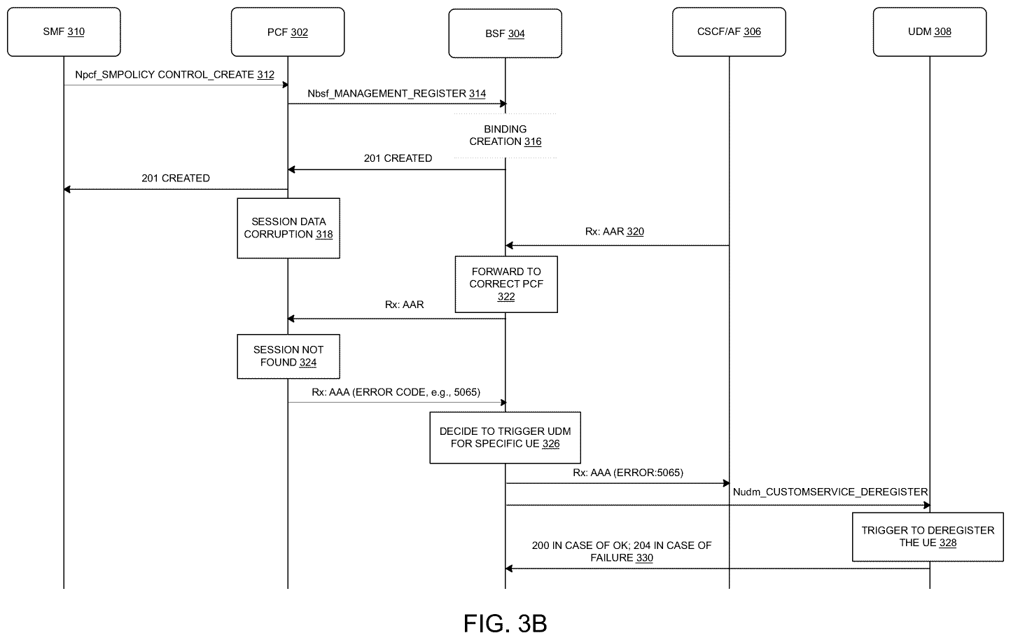

FIG. 3A illustrates an exemplary block diagram representation of system architecture (300) for managing users in a network, in accordance with an embodiment of the present disclosure.

The system architecture (300) may include a Policy Control Function (PCF) (302), a Binding Support Function (BSF) (304), an Application Function (AF)/Call Session Control Function (CSCF)/(AF/CSCF) (306), and a Unified Data Manager function (UDM) (308). The PCF (302) may create a binding session, via a NBSF Service Based Interface (SBI) and Reception (Rx) interface, in the BSF (304) upon reception of a “Npcf_SMPolicyControl_Create/Update” message, by transmitting a “Nbsf_Management_Register” message to the BSF (304). The CSCF/AF (306) may transmit, in case of call initiation, an Authorization Authentication Request (AAR) message to the BSF (304). The BSF (304) may initiate, upon receiving the error code by the BSF, via a custom NUDM interface, communication to the UDM (308) and transmit a “ReRegister” service operation to the UDM (308).

### Exemplary Scenario 1

For example, in a scenario, when a session is removed from the PCF (302) or the BSF (304), but is still present in the SMF (not shown), there are chances that subscribers such as the user (102) may try to call another user (102). However, the call may not be connected as Rx session establishment may end with an error. This error may not have any impact on the existing session at the SMF. Hence, the user (102) may not be able to resolve the issue till the user (102) restarts the UE such as the computing device (104). Hence, the UDM (308) may decide to send a notification to the SMF to either delete/re-establish the PDU session or may also decide to deregister and register the subscriber via the AMF. The feature of deleting/re-establishing the PDU session or deregistering and then registering the subscriber may be an enhancement to the network-initiated action.

### Exemplary Scenario 2

In case of network faults, a call from the user (102) may not be completed due to session information not being present in the PCF (302)/BSF (304). This may result in a poor user experience and the user (102) may not be able to resolve the issue till the UE is restarted for re-registration. By releasing the subscriber session to handle such network fault automatically may improve user experience.

FIG. 3B illustrates an exemplary sequence diagram representation for managing users in a network, in accordance with an embodiment of the present disclosure.

At step (312), the SMF (310) may transmit the “Npcf_SMPolicyControl_Create/Update” message to the PSF (302). At step (314), the PSF (302) may transmit the “Nbsf_Management_Register” message to the BSF (304). At step (316), the BSF (304) may create a binding session, upon reception of the “Nbsf_Management_Register” message. The acknowledgment “201 created” may be transmitted to the SMF (310) via the PCF (302), upon creating the binding session.

At step (318), due to database fault or network fault, the session for the SUPI in question may be deleted from the PCF (302), but not from the BSF or the SMF (310). At step (320), the CSCF/AF (306) may transmit, in case of call initiation, an Authorization Authentication Request (AAR) message, to the BSF (304).

At step (322), the BSF (304) may check the local Database (DB) for binding data for SUPI in question and find an entry for the binding data. Based on the entry, the BSF (304) forwards the AAR to an appropriate PCF (302). At step (324), the PCF (302) may not include session data for the SUPI, the PCF (302) may respond with a 5065 result code to the BSF (304).

At step (326), may the BSF (304) may initiate, upon receiving the error code, communication to the UDM (308) and transmit a “ReRegister” service operation to the UDM (308). In an embodiment, the UDM (308) may internally interact, upon receiving the “ReRegister” service operation, with the AMF/SMF (310). At step (318), the UDM (308) may decide to send a notification to the SMF (310) to either delete/re-establish the PDU session or may also decide to deregister and register the subscriber via the AMF. At step (330), the BSF (304) may remove the binding data from self and forwards a 5065 error code to the AF/CSCF (306).

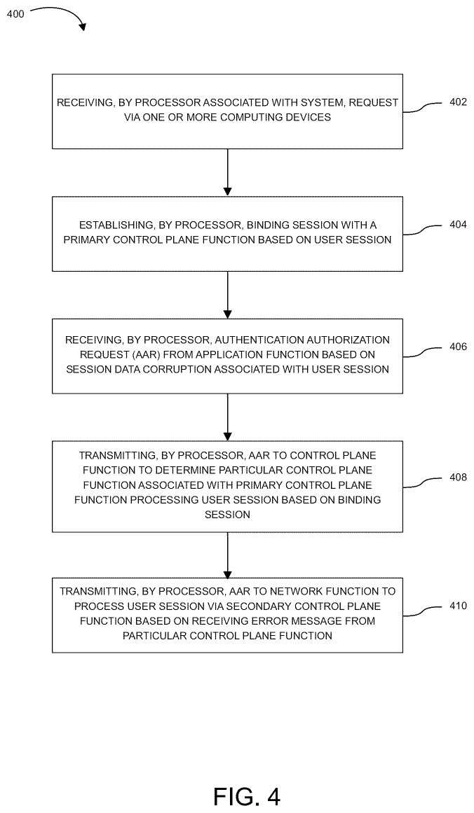

FIG. 4 illustrates an exemplary flow diagram for a method (400) for managing users in a network, in accordance with embodiments of the present disclosure. At step (402), the method (400) includes receiving, by the processor (202) associated with a system (108), a request via one or more computing devices (104). At step (404), the method (400) includes establishing, by the processor (202), the binding session with a primary control plane function based on the user session. At step (406), the method (400) includes receiving, by the processor (202), the AAR from the application function based on a session data corruption associated with the user session. At step (408), the method (400) includes transmitting, by the processor (202), the AAR to the control plane function to determine a particular control plane function associated with the primary control plane function processing the user session based on the binding session. At step (410), the method (400) includes transmitting, by the processor (202), the AAR to a network function to process the user session via an secondary control plane function based on receiving an error message from the particular control plane function.

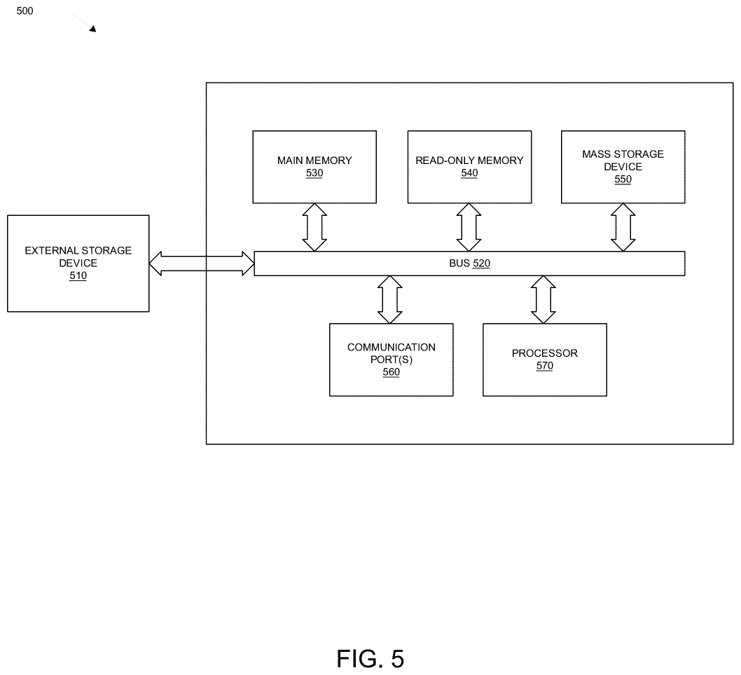

FIG. 5 illustrates an exemplary computer system (500) in which or with which embodiments of the present invention can be utilized, in accordance with embodiments of the present disclosure.

As shown in FIG. 5, the computer system (500) can include an external storage device (510), a bus (520), a main memory (530), a read-only memory (540), a mass storage device (550), communication port (560), and a processor (570). A person skilled in the art will appreciate that the computer system may include more than one processor and communication ports. Examples of processor (570) include, but are not limited to, an Intel® Itanium® or Itanium 2 processor(s), or AMD® Opteron® or Athlon MP® processor(s), Motorola® lines of processors, FortiSOC™ system on chip processors or other future processors. Processor (570) may include various modules associated with embodiments of the present invention. Communication port (560) can be any of an RS-232 port for use with a modem-based dialup connection, a 10/100 Ethernet port, a Gigabit, or 10 Gigabit port using copper or fibre, a serial port, a parallel port, or other existing or future ports. Communication port (560) may be chosen depending on a network, such as a Local Area Network (LAN), Wide Area Network (WAN), or any network to which the computer system connects. Memory (530) can be Random Access Memory (RAM), or any other dynamic storage device commonly known in the art. Read-only memory (540) can be any static storage device(s) e.g., but not limited to, a Programmable Read-Only Memory (PROM) chips for storing static information e.g., start-up or BIOS instructions for the processor (570). Mass storage (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 782 family) or Hitachi (e.g., the Hitachi Deskstar 13K800), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus (520) communicatively couple's processor(s) (570) with the other memory, storage, and communication blocks. Bus (520) can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor (570) to a software system.

Optionally, operator and administrative interfaces, e.g., a display, keyboard, and a cursor control device, may also be coupled to the bus (520) to support direct operator interaction with a computer system. Other operator and administrative interfaces can be provided through network connections connected through a communication port (560). The external storage device (510) can be any kind of external hard drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter is to be implemented merely as illustrative of the invention and not as a limitation.

### ADVANTAGES OF THE PRESENT DISCLOSURE

The present disclosure provides systems and methods for managing users in a network.

The present disclosure provides systems and methods for DeRegistering/Re-Registering of a subscriber by triggering the appropriate Application Programming Interface (API) to a Unified Data Manager function (UDM).

The present disclosure overcomes overloading of the Unified Data Manager function (UDM) by the Binding Support Function (BSF), in case of bulk session failure from the Policy Control Function (PCF) or at the BSF.

The present disclosure provides systems and methods for removing binding data (and/or diameter data), if applicable for Subscription Permanent Identifier (SUPI) for which UDM API has been triggered.

The present disclosure resolves the issue of restarting User Equipment (UE) for network faults or Rx Session establishment with error, based on providing network-initiated action based on rare occurrences for such cases by initiating communication to the UDM and sending “ReRegister” service operation to UDM.

### RESERVATION OF RIGHTS

A portion of the disclosure of this patent document contains material that is subject to intellectual property rights such as, but are not limited to, copyright, design, trademark, IC layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner. The present disclosure is in accordance with Third Generation Partnership Project (3GPP) Technical Specifications such as 3GPP TS 29.512, 3GPP TS 29.212, 3GPP TS 29.521, and the like.

1. A system for managing users in a network, the system comprising:
a processor; and
a memory operatively coupled with the processor, wherein said memory stores instructions, which when executed by the processor, cause the processor to:
receive a request via one or more computing devices, wherein the computing devices are associated with the one or more users, and wherein the request is based on a user session requested by the one or more users;
establish a binding session with a primary control plane function based on the user session;
receive an authentication authorization request (AAR) from an application function based on a session data corruption associated with the user session;
transmit the AAR to the control plane function to determine a particular control plane function associated with the primary control plane function processing the user session based on the binding session; and
transmit the AAR to a network function to process the user session via an secondary control plane function based on receiving an error message from the particular control plane function.

2. The system as claimed in claim 1, wherein the processor is to re-establish the user session by receiving a protocol data unit (PDU) session from the secondary control plane function.

3. The system as claimed in claim 2, wherein the processor is to terminate the user session by receiving the PDU session from the secondary control plane function.

4. The system as claimed in claim 2, wherein the secondary plane function is to process the user session via an access and mobility management function (AMF).

5. The system as claimed in claim 2, wherein the processor is to terminate the binding session upon the re-establishment of the user session and transmit the error message to the application function.

6. The system as claimed in claim 1, wherein the processor is to activate the secondary control plane function automatically prior to transmitting the error message to the application function.

7. The system as claimed in claim 1, wherein the binding session comprises at least one of: a subscription permanent identifier (SUPI), a data network name (DNN), and a network slice associated with the user session.

8. The system as claimed in claim 1, wherein the primary control plane function is a policy control function (PCF) and wherein the secondary control plane function is a unified data manager function (UDM).

9. A method for managing users in a network, the method comprising:
receiving, by a processor associated with a system, a request via one or more computing devices, wherein the request is based on a user session requested by the one or more users;
establishing, by the processor, a binding session with a primary control plane function based on the user session;
receiving, by the processor, an authentication authorization request (AAR) from an application function based on a session data corruption associated with the user session;
transmitting, by the processor, the AAR to the control plane function to determine a particular control plane function associated with the primary control plane function processing the user session based on the binding session; and
transmitting, by the processor, the AAR to a network function to process the user session via an secondary control plane function based on receiving an error message from the particular control plane function.

10. The method as claimed in claim 9, comprising re-establishing, by the processor, the user session by receiving a protocol data unit (PDU) session from the secondary control plane function.

11. The method as claimed in claim 10, comprising terminating, by the processor, the user session by receiving the PDU session from the secondary control plane function.

12. The method as claimed in claim 10, comprising terminating, by the processor, the binding session upon the re-establishment of the user session and transmitting the error message to the application function.

13. The method as claimed in claim 10, comprising activating, by the processor, the secondary control plane function automatically prior to transmitting the error message to the application function.

14. The method as claimed in claim 10, wherein the binding session comprises at least one of: a subscription permanent identifier (SUPI), a data network name (DNN), and a network slice associated with the user session.

15. The method as claimed in claim 10, wherein the primary control plane function is a policy control function (PCF) and wherein the secondary control plane function is a unified data manager function (UDM).

16. A non-transitory computer readable medium comprising a processor with executable instructions, causing the processor to:
receive a request via one or more computing devices, wherein the computing devices are associated with the one or more users, and wherein the request is based on a user session requested by the one or more users;
establish a binding session with a primary control plane function based on the user session;
receive an authentication authorization request (AAR) from an application function based on a session data corruption associated with the user session;
transmit the AAR to the control plane function to determine a particular control plane function associated with the primary control plane function processing the user session based on the binding session; and
transmit the AAR to a network function to process the user session via an secondary control plane function based on receiving an error message from the particular control plane function.
